(19) United States
(12) Patent Application Publication
(10) Pub. No.: US 2008/0119079 A1
(43) Pub. Date: May 22, 2008

(54) Oil-bleeding rubber plug and waterproof connector

(75) Inventors: Shogo Suzuki, Makinohara-shi (JP); Kazuki Zaitsu, Makinohara-shi (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 11/979,783

(22) Filed: Nov. 8, 2007

(30) Foreign Application Priority Data
Nov. 20, 2006 (JP) 2006-312364

(51) Int. Cl. H01R 13/52

(52) U.S. Cl. 439/281; 428/331

(57) ABSTRACT

The present invention is to provide a rubber plug for maintaining waterproof performance with the rubber plug scratched, and a waterproof connector utilizing the rubber plug. The rubber plug includes oil reservoirs to reserve oil bleeding from the rubber plug. The oil reservoirs are formed as recesses circularly disposed in top portions of lip portions and closely contact around terminals connected with electrical cables. The oil reservoirs feed oil to the scratch caused in the rubber plug to maintain sealability.

### BACKGROUND OF THE INVENTION

1. Field of the Invention

The present invention relates to an oil-bleeding rubber plug and a waterproof connector utilizing the oil-bleeding rubber plug.

2. Description of the Related Art

A waterproof connector includes a connector housing, a rubber plug, a rear holder, and a plurality of terminals connected with electrical cables (JP-2005-158595, A). The connector housing has a plurality of terminal receiving chambers and a rubber plug mounting portion communicating with the terminal receiving chambers. The rubber plug has a plurality of electrical cable insertion holes to accept insertion of the terminals and is fitted into the rubber plug mounting portion of the connector housing. The rear holder holds the rubber plug to avoid fall of the rubber plug from a rear portion of the connector housing. The rear holder is fitted into the rear portion of the connector housing. The rear holder has terminal insertion holes aligned with the electrical cable insertion holes. The terminals are attached to end portions of the electrical cables.

The waterproof connector is assembled in the following manner. The rubber plug is fitted into the rubber plug mounting portion of the connector housing and the rear holder is fitted into the connector housing. The terminal connected with the electrical cable is inserted into the terminal insertion hole and further into the rubber plug by resiliently widening the electrical cable insertion hole and received in the terminal receiving chamber. The same steps are repeated by the number of the terminals. When the terminals are received in the terminal receiving chambers after assembly of the waterproof connector, the electrical cables fit in the electrical cable insertion holes of the rubber plug so that the sealability of the waterproof connector is assured.

Specification of the waterproof connector of an electrical circuitry of a motor vehicle has become strict. An oil-bleeding rubber is utilized for the rubber plug for sealing (JP-H06-116445, A). The oil-bleeding rubber contains oil therein and the oil bleeds to a surface of the rubber.

When terminals connected with electrical cables are inserted into electrical cable insertion holes of a rubber plug with a resilient widening, force-insertion of the terminals or a contact of stabilizers of the terminals with the rubber plug causes a scratch in the rubber plug, resulting in loss of sealability.

### SUMMARY OF THE INVENTION

The present invention is to provide a rubber plug which maintains waterproof with the rubber plug being scratched, and a waterproof connector utilizing the rubber plug.

According to a first aspect of the present invention, an oil-bleeding rubber plug has an oil reservoir, the oil reservoir being formed as a recess circularly disposed in an interior surface of the oil-bleeding rubber plug which allows an insertion of a terminal connected with an electrical cable.

The oil bleeding from the rubber plug is reserved in the oil reservoir. The oil in the oil reservoir bleeds to a scratch on the rubber plug caused by insertion of a terminal and thus maintains sealability.

Preferably, the oil reservoir is disposed in a lip portion of the interior surface of the oil-bleeding rubber plug.

The lip portion including the oil reservoir is resilient and closely contacts an outer surface of the terminal so as to maintain sealability.

According to a second aspect of the present invention, a waterproof connector includes: a connector housing having a terminal receiving chamber and a rubber plug mounting portion connected with the terminal receiving chamber; and an oil-bleeding rubber plug to be fitted to the rubber plug mounting portion, wherein an oil reservoir is formed as a recess circularly disposed in an interior surface of the oil-bleeding rubber plug and/or in an interior surface of a connection portion of the terminal receiving chamber and the rubber plug mounting portion, and the oil-bleeding rubber plug allows an insertion of a terminal connected with an electrical cable.

The oil bleeding from the rubber plug is reserved in the oil reservoir of the rubber plug and/or the oil reservoir of the connector housing. The oil in the oil reservoir of the rubber plug bleeds to a scratch on the rubber plug caused by insertion of the terminal and maintains sealability. On the contrary, the oil in the reservoir of the connector housing prevents invasion of water into a terminal receiving chamber and maintains sealability.

Preferably, the waterproof connector includes a rear holder to be fitted into the connector housing, wherein the oil-bleeding rubber plug is compressed with the rear holder.

### BRIEF DESCRIPTION OF THE DRAWINGS

FIG. 1A is a sectional view of a first embodiment of a rubber plug and a waterproof connector prior to insertion of a terminal into a connector housing;

FIG. 1B is an enlarged sectional view of an essential portion of the rubber plug;

FIG. 2A is a sectional view of the connector housing, the rubber plug, and a rear holder;

FIG. 2B is the enlarged sectional view of the essential portion of the rubber plug;

FIG. 3 is a sectional view of the assembled waterproof connector;

FIG. 4 is a side view of a male terminal connected with an electrical cable; and

FIG. 5 is a sectional view of an essential portion of another embodiment of a rubber plug and a waterproof connector of the present invention.

### DETAILED DESCRIPTION OF THE PREFERRED EMBODIMENTS

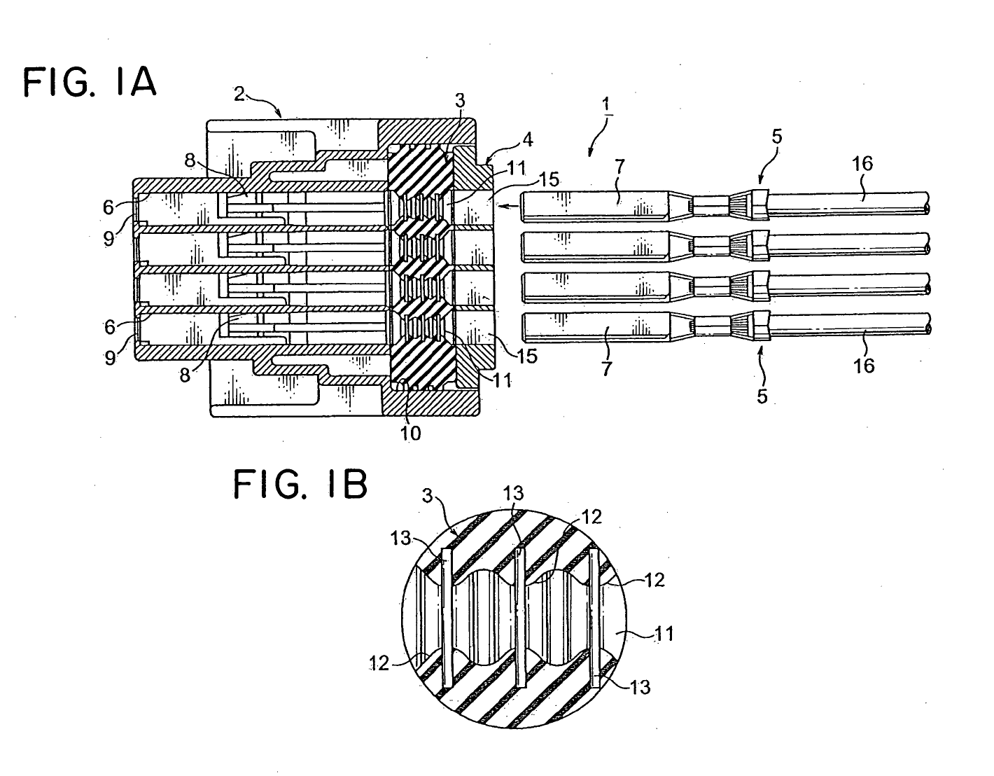

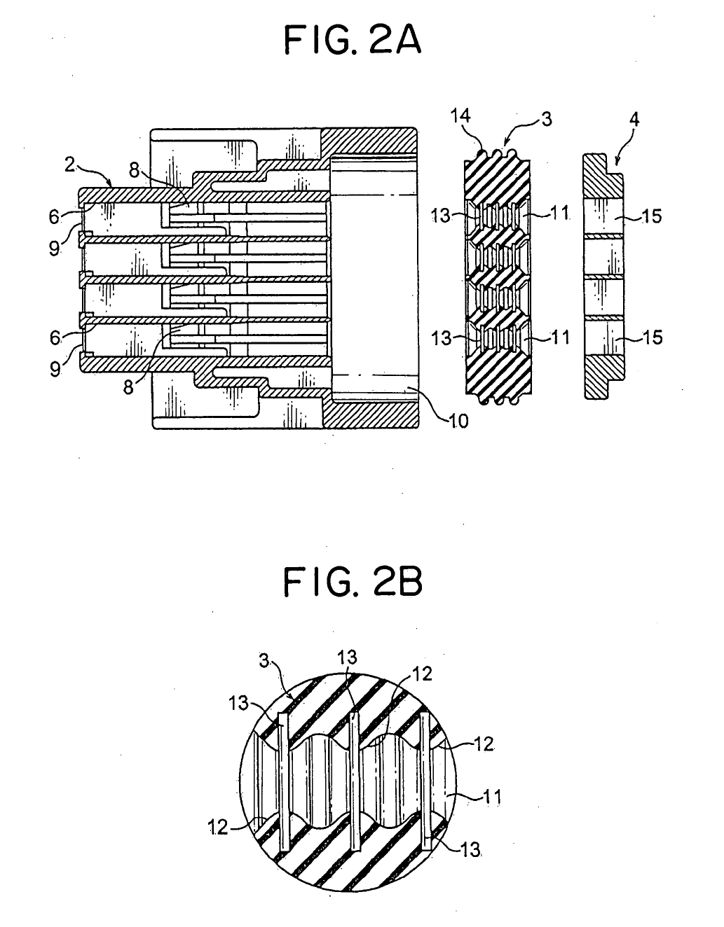

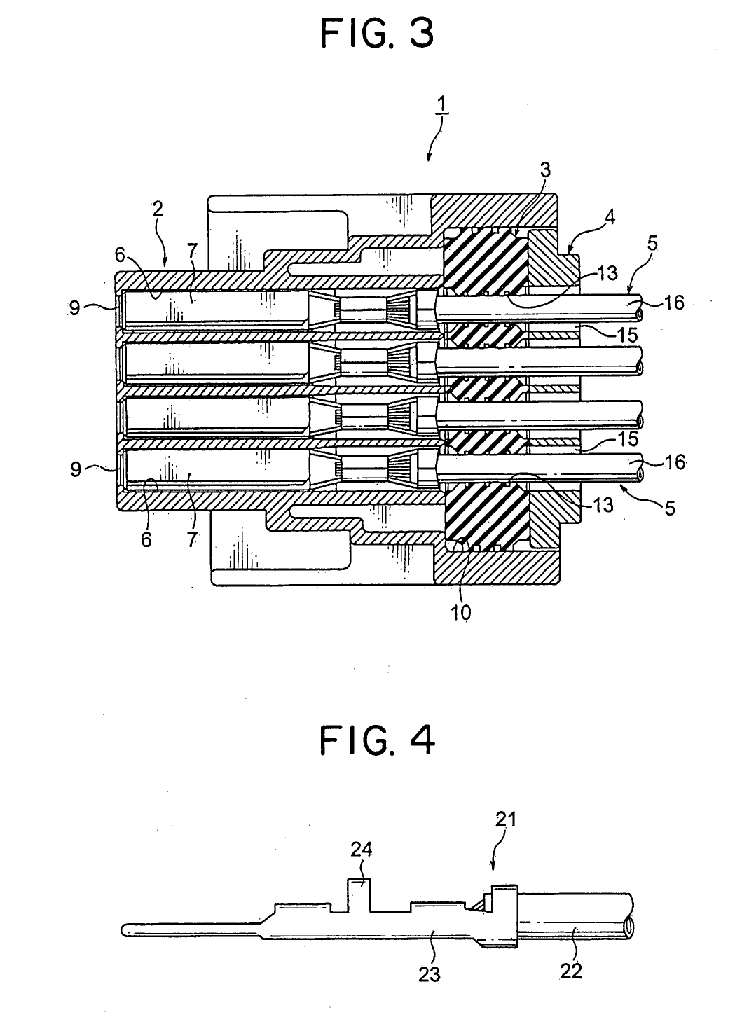

The present invention is explained by referring to drawings. FIG. 1A is a sectional view of a waterproof connector 1 prior to insertion of terminals 5 connected with electrical cables 16. FIG. 1B is an enlarged sectional view of an essential portion of a rubber plug 3. FIG. 2A is sectional views of a connector housing 2, the rubber plug 3 and a rear holder 4. FIG. 2B is the enlarged sectional view of the essential portion of the rubber plug 3. FIG. 3 is a sectional view of the assembled waterproof connector 1.

The waterproof connector 1 includes the connector housing 2, the rubber plug 3, the rear holder 4, and the terminals 5 with the electrical cables 16. An object of the present invention is to provide the waterproof connector 1 having a good waterproof performance. FIGS. 1A-3 show a configuration of a first embodiment of the waterproof connector 1 having female terminals 7 of the present invention.

The connector housing 2 is made of an insulation synthetic resin and includes a plurality of terminal receiving chambers 6. The terminal receiving chambers 6 receive the female terminals 7 of the electrical terminals 5 attached with the electrical cables 16. The terminal receiving chambers 6 include lances 8 to lock the female terminals 7, and openings 9 to accept male terminals at a front end thereof. The connector housing 2 includes a rubber plug mounting portion 10 behind the terminal receiving chambers 6.

The openings 9 of the terminal receiving chambers 6 are adapted for accepting the mating male terminals (not shown) into the terminal receiving chambers 6 when the waterproof connector 1 and a mating connector (not shown) are fitted together. The openings 9 are disposed at the front ends of the connector housing 2 and are communicated with the terminal receiving chambers 6.

The rubber plug mounting portion 10 has a large recess to receive the rubber plug 3 and is communicated with the terminal receiving chambers 6. The rubber plug mounting portion 10 includes an opening and a depth to accept the rubber plug 3 and the rear holder 4 therein. The rubber plug mounting portion 10 includes a locking portion (not shown) to lock the rear holder 4.

The rubber plug 3 is made of an oil-bleeding rubber and has one integral structure. The oil-bleeding rubber is such as silicon oil rubber or polyolefin rubber containing silicon oil disclosed in JP-H06-116445,A, where the polyolefin rubber is a liquid polyolefin copolymer or a cross-linkable copolymer of the liquid polyolefin copolymer and a rubber polyolefin copolymer.

The rubber plug 3 has a rectangular shape in plan view, and an enough thickness to ensure sealability. The rubber plug 3 has a plurality of electrical cable insertion holes 11 aligned with the respective terminal receiving chambers 6. The rubber plug 3 has a plurality of corrugated interior surfaces each defining an outer surface in a circumferential direction of the associated electrical cable insertion hole 11. Inwardly extending portions of the corrugated surfaces form lip portions 12 which include oil reservoirs 13 at top portions thereof.

The oil reservoirs 13 reserve the oils bleeding from the rubber plug 3. The oil reservoirs 13 are formed as recesses in the top portions of the lip portions 12 so as to contact outer surfaces of the electrical cables 16. The oil reservoirs 13 are thus disposed on a circumferential direction of an insertion direction of the terminals 5. The oil reservoirs 13 feed oil to a scratch caused on the rubber plug 3 to maintain sealability. The oil reservoirs 13 have a volume capacity to maintain sealability.

The rubber plug 3 has a plurality of lip portions 14 at an exterior surface thereof and the exterior lip portions 14 closely contact the rubber plug mounting portion 10 when they are assembled. A front and rear end portions of the rubber plug 3 have flat surfaces so as to face-to-face contact the connector housing 2 and the rear holder 4, respectively. The rubber plug 3 is held between the connector housing 2 and the rear holder 4 and compressed with the rear holder 4.

The rear holder 4 is made of an insulation synthetic resin and covers the rear portion of the connector housing 2. The rear holder 4 compresses the rubber plug 3 when the rear holder 3 is attached to the connector housing 2. The rear holder 4 has a plurality of terminal insertion holes 15 aligned with the electrical cable insertion holes 11. The rear holder 4 has a catching portion to be locked with a locking portion (not shown) of the rubber plug mounting portion 10.

The terminals 5 include the female terminals 7 crimping the electrical cables 16.

Assembly of the waterproof connector 1 is explained below. The assembly includes a first and second stages.

The first stage includes steps of mounting the rubber plug 3 to the rubber plug mounting portion 10 of the connector housing 2 and fitting the rear holder 4 to the rubber plug mounting portion 10. When the rear holder 4 is fitted into the rear portion of the connector housing 2 and compresses the rubber plug 3, the oil contained in the rubber plug 3 bleeds to the electrical cable insertion hole 11 and the oil reservoirs 13.

The second stage includes step of inserting the terminals 5 with the electrical cables 16 into the relevant terminal insertion holes 15 of the rear holder 4. The terminals 5 are inserted into the electrical cable insertion holes 11 of the rubber plug 3 by resiliently widening the insertion holes 11 through the terminal insertion holes 15. The terminals 5 are received in the terminal receiving chambers 6 of the connector housing 2. The assembly is repeated by the number of the terminals 5 to complete assembly of the waterproof connector 1.

When the female terminals 7 are received in the terminal receiving chambers 6, the electrical cable insertion holes 11 and the electrical cables 16 are closely contacted each other to provide sealability therebetween. When the insertion of the terminals 5 (female terminals 7) causes the scratch on the rubber plug 3, the oil in the reservoirs 13 bleeds into the scratch and maintains sealability of the waterproof connector 1.

It is apparent from FIGS. 1A-3 that sealability of the waterproof connector 1 is maintained even though the scratch is caused on the rubber plug 3.

FIG. 4 shows that a terminal 21 connected with an electrical cable 22 includes a male terminal 23 having a stabilizer 24. The stabilizer 24 sometimes causes the scratch on the rubber plug 3. The oil in the oil reservoirs 13 of the rubber plug 3 bleeds to the scratch and maintains sealability of the waterproof connector 1 for the male terminals 23.

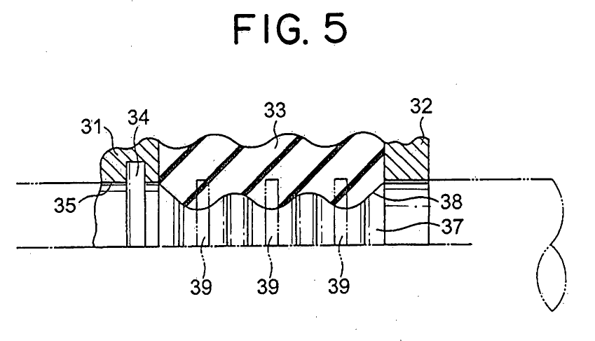

FIG. 5 shows a connector housing 31 including an oil reservoir 34 to reserve oil bleeding out of a rubber plug 33 made of an oil-bleeding rubber. The rubber plug 33 is also compressed with a rear holder 32. The oil reservoir 34 is formed as a recess circularly disposed in an interior surface 35 of a connection portion between a terminal receiving chamber and a rubber plug mounting portion. The connector housing 31 shown in FIG. 5 is suitable for the terminal having a smaller diameter than an electrical cable. It is more preferable to form oil reservoirs 39 in lip portions 38 of the rubber plug 33.

Any modification and alteration are within scope of the present invention.

What is claimed is:

1. An oil-bleeding rubber plug having an oil reservoir, the oil reservoir being formed as a recess circularly disposed in an interior surface of the oil-bleeding rubber plug which allows an insertion of a terminal connected with an electrical cable.

2. The oil-bleeding rubber plug as claimed in claim 1, wherein the oil reservoir is disposed in a lip portion of the interior surface of the oil-bleeding rubber plug.

3. A waterproof connector comprising:
a connector housing having a terminal receiving chamber and a rubber plug mounting portion connected with the is terminal receiving chamber; and
an oil-bleeding rubber plug to be fitted to the rubber plug mounting portion,
wherein an oil reservoir is formed as a recess circularly disposed in an interior surface of the oil-bleeding rubber plug and/or in an interior surface of a connection portion of the terminal receiving chamber and the rubber plug mounting portion, and the oil-bleeding rubber plug allows an insertion of a terminal connected with an electrical cable.

4. The waterproof connector as claimed in claim 3, further comprising a rear holder to be fitted into the connector housing, wherein the oil-bleeding rubber plug is compressed with the rear holder.
